(19) United States
(12) Patent Application Publication
(10) Pub. No.: US 2009/0160450 A1
(43) Pub. Date: Jun. 25, 2009

(54) METHOD AND DEVICE FOR PROVIDING DIAGNOSTICS FOR AN INTERNAL COMBUSTION ENGINE IGNITION COIL

(75) Inventor: Daniel Stauner, Lardy (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., BOULOGNE-BILLANCOURT (FR)

(21) Appl. No.: 12/096,258

(22) PCT Filed: Nov. 30, 2006
(86) PCT No.: PCT/FR06/51265

§ 371 Date: Aug. 15, 2008

(30) Foreign Application Priority Data
Dec. 5, 2005 (FR) 0553728

(51) Int. Cl. F02P 17/00

(52) U.S. Cl. 324/388

(57) ABSTRACT

A method providing diagnostics of operation of an internal combustion engine ignition coil further including at least one electric cable connecting the ignition coil to at least one spark plug installed in a cylinder head of the engine. The method temporarily introduces a voltage-controlled switch into the ignition circuit, causing the coil to supply a diagnostics voltage higher than a threshold value needed for the spark plug to form a spark, so as to cause a spark to form between the central electrode of the spark plug and a conducting element of the switch, and checks that a spark actually is formed in response to the supply.

The present invention relates to a diagnostic device for diagnosing a component forming part of internal combustion engines. It relates more specifically to the detection of a malfunction in an ignition coil of such an engine.

The traditional way that garage mechanics check the operating state of the ignition coil is that, after putting the engine into operation while the vehicle is stationary, they disconnect the power cable from a spark plug and bring the power connector toward a ground point on the vehicle. The diagnostic test is performed by viewing the sparks being created between the power cable connected to the ignition coil and the ground point on the vehicle. In order to force the coil to provide an additional voltage, the mechanic gradually moves the electrode connected electrically to the coil away from the ground point on the vehicle.

This empirical technique for diagnosing the coil depends to a large degree on the mechanic's experience and dexterity and is thus not particularly reliable. Moreover, it may lead to the destruction of the coil by piercing the insulator protecting it if the mechanic moves the electrode too far away from the ground point on the engine.

Furthermore, it is only possible for the mechanic to perform tests relating to the ignition coil operation while the vehicle is stationary. However, the ignition voltage requirements are lower with the vehicle stationary than when the engine is accelerating under full load. It is possible that a coil provides sufficient voltage with the vehicle stationary but that it is deficient for certain operating points. This deficiency cannot be detected by the operator if he employs the above-described method.

For the purposes of performing diagnostics on the various elements of the engine, a “diagnostic toolbox” composed of a portable computer connected to the engine computers and in dialogue therewith has also been proposed.

However, this type of toolbox is difficult to implement and it is complicated to interpret the information collected. Furthermore, costly computer modules specifically dedicated to ignition diagnosis are necessary to detect a malfunction of the coil.

The present invention proposes to overcome the disadvantages of the prior art by providing a method and device for diagnosing the operating state of the ignition coil that is inexpensive, particularly simple to implement and independent of the level of experience of the operator.

Another object of the present invention is to provide a method and a device for implementing same whereby the operation of the coil can be tested for all its operating points without damaging the coil or the ignition circuit.

The invention provides a diagnostic method for diagnosing the operation of an ignition coil of an internal combustion engine, additionally comprising at least one electric cable connecting the ignition coil to at least one spark plug installed in a cylinder head of the engine, characterized in that the method comprises at least the steps consisting in:
temporarily introducing a voltage-controlled switch into the ignition circuit,
making the coil provide a so-called diagnostic voltage, which is above a threshold value necessary for the plug to form a spark,
making the coil provide a so-called diagnostic voltage, which is above a threshold value necessary for the plug to form a spark, so as to cause the formation of a spark, between the central electrode of the ignition coil and a conducting element of the switch, and
checking the actual formation of a spark in response to providing said diagnostic voltage.

The checking step consists in observing engine misfires.

According to one feature of the invention, the step of checking the formation of a spark consists in viewing an image of the current flowing through the switch.

The checking step consists in viewing a spark produced within the switch.

The invention also provides a diagnostic device for diagnosing the operation of an ignition coil of an internal combustion engine, additionally comprising at least one electric cable connecting the coil to at least one spark plug installed in the cylinder head of the engine, characterized in that said device comprises a conducting element intended, on the one hand, to be electrically and temporarily connected to the ignition coil to be tested and, on the other hand, intended to be arranged, during the diagnostic test, at an adjustable non-zero distance from the part, outside the cylinder head, of the central electrode of said spark plug so as to allow the formation of a spark, between the central electrode of the spark plug and the conducting element, during the operation of the engine.

The conducting element is fixedly attached to an insulating element in which it is partially housed, and the length of the insulating element is a function of the distance d.

The conducting element is a metal rod housed in a passage formed in the insulating element, said rod projecting inside and outside the insulating element.

The insulating element is a tube, the passage being substantially coaxial with the axis of the insulating tube, the rod being adhesively bonded or screwed to the tube over a portion of its length.

The conducting element is the central electrode of a test spark plug not provided with its ground electrode, said test plug being partially inserted into the insulating tube at its end opposed to the spark plug.

The insulating element comprises an inspection port for inspecting the formation of a spark in the insulating tube during the diagnostic test.

An element facilitating the view of the spark is inserted into the inspection port.

Other features and advantages of the present invention will become more clearly apparent on reading the non-limiting, detailed description of a number of embodiments of the present invention with reference to the appended drawings, in which:

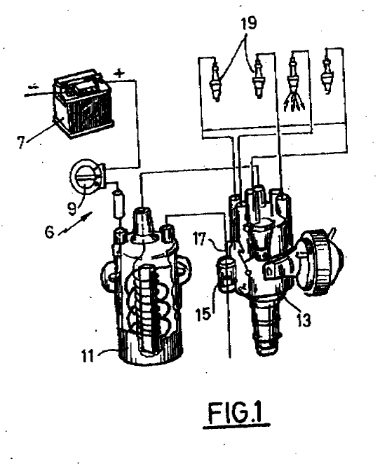

FIG. 1 is a schematic view of a conventional ignition circuit;

FIG. 2 is a schematic view in axial section of a first embodiment of the device according to the invention;

FIG. 3 is a schematic view in axial section of a second embodiment of the present invention;

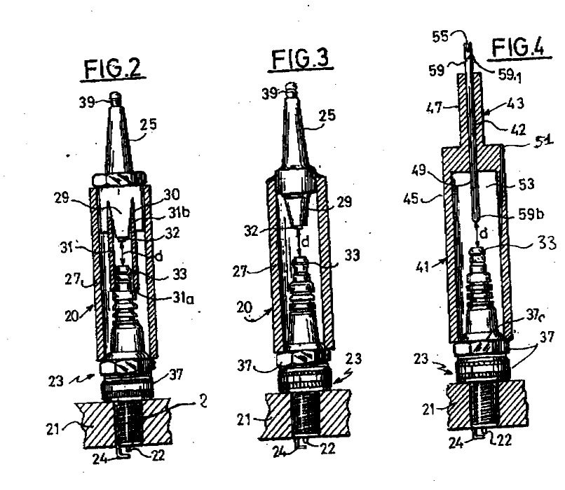

FIG. 4 is a schematic view in axial section of the preferred embodiment of the present invention.

Reference will now be made to FIG. 1. The conventional ignition circuit 6 comprises a coil 11 whose primary winding is connected in series with an accumulator battery 7 and is electromagnetically coupled, to constitute a voltage transformer, to a secondary winding placed in a high-voltage circuit comprising an ignition gap belonging to a spark plug 19. In this ignition system, the intermittent interruptions are produced by a contact breaker 17 interposed in the electric line for the return to ground of the coil winding. The contact breaker 17 is caused to open and close by an electronic control unit. The contact breaker 17 is an element of the distributor 13. At the moment the primary circuit closes, the current builds up gradually, and, when it opens, this current is then diverted toward the capacitor 15 connected to the terminals of the contact breaker 17. The capacitor is charged with self-induced current and then discharges immediately. The sudden variation in the flux in the primary circuit causes the formation of a high-voltage current in the secondary winding which is then distributed toward one of the plugs 19.

The method and the device according to the invention make it possible to detect a malfunction in the coil 11 of the coil type presented above.

The device and the method according to the invention make it possible to artificially create an additional voltage requirement to force the coil to provide a high voltage close to the maximum voltage value that it can provide. More precisely, during a normal operation in idle mode, the spark plug must provide a voltage of between 10 and 15 kV. The method and the device according to the invention make it possible, for example, to force the coil to provide a voltage which is higher than 25 kV.

Furthermore, the voltage requirement changes with the ageing of the plugs. Indeed, the ignition voltage for the formation of a spark reaches a value of around 30 kV when the plug is worn. Since the threshold that should be reached by the spark plug is around 25 kV, it guarantees an effective test for the majority of spark plugs.

With reference to FIG. 2, a spark plug 23, similar to one of the plugs 19 in FIG. 1, is shown in a mounted position in a cylinder head 21 of the internal combustion engine. The device 20 according to the invention is composed of a second test plug 25, which is not provided with a ground electrode, and of a first external insulating tube 27 whose internal diameter is slightly larger than that of the lower ceramic tip 29 of the test plug 25. The tube 27 is screwed or adhesively bonded to the ceramic tip 29. The device according to the invention also comprises a second internal insulating tube 31 which has a smaller diameter than the first insulating tube 27 and is coaxial therewith, the first tube 31 being able to be fitted at one of its ends 31.a to that end 33 of the plug which is opposed to the lower ground electrode. The other end 31.b of the second insulating tube 31 is adhesively bonded to the ceramic tip 29 of the test plug 25.

To make it easier to position the test plug 25 on the insulating tube 31, a concave frustoconical cutout 30 is formed in the ceramic tip 29. The end 31.b of the insulating tube 31 that is intended to be adhesively bonded to the ceramic tip 29 has a shape complementing that of the concave cutout 30 and is inserted into the latter so that the assembly can be joined together by adhesive bonding.

The internal insulating tube 31 has the purpose, during the use of the device, of preventing the formation of a spark between the central electrode 32 of the test plug 25 and the shell 35 of this same plug, or between the central electrode 32 of the test plug 25 and a metal surface of the engine, for example one belonging to the plug well.

In order to test the spark plug, the electric ignition harness connecting the plug 23 to the rest of the ignition circuit is disconnected. The device 20 according to the invention is then positioned on the spark plug 23. More precisely, the internal tube 31 is positioned on the free end 33 of the spark plug 23, while the external tube 27 butts against the shell 37 of the spark plug 23. The respective length of the two tubes is a function of the distance “d” that it is desired to leave between the central electrode of the test plug 25 and the conducting free end 33 of the spark plug. This distance “d” is a function of the voltage that it is desired to have the coil provide during the diagnostic test. The corresponding cable of the electric ignition harness is then connected to the free end 39 of the test plug 25. The engine is then put into operation.

If the ignition coil is deficient, the voltage that it provides will be insufficient for the formation of a spark, on the one hand between the central electrode 32 of the test plug 25 and the conducting free end 33 of the spark plug, and, on the other hand, between the electrodes 22 and 24 of the spark plug 23. Misfires will occur. These measured and/or perceived misfires or an increase in the rate of misfires indicate that the coil is presumed to be faulty.

FIG. 3 presents a simplified embodiment in relation to the above-described embodiment. Specifically, in this embodiment, the shell 35 of the test plug and the internal insulator tube 31 have been omitted.

The use of the device according to this embodiment is in accordance with the description given above.

In the case of the two preceding embodiments, the value of the additional voltage necessary for establishing an electric arc between the central electrode 32 of the test plug 25 and the conducting free end 33 of the spark plug is adjusted through the choice of length of the outer tube 27 or length of the internal tube 31 if present.

In the embodiment shown in FIG. 4, the device according to the invention comprises an insulating element 41, or insulating tube 41, composed of two coaxial cylinders 45 and 47. A first cavity-forming lower cylinder 45 is open at its end and the second smaller-diameter upper cylinder 47 is made in one piece with the first cylinder 45. An axial passage 42 which runs through the upper cylinder 47 and opens into the internal cavity of the lower cylinder 45 is formed in the insulating element 41. This passage opens into the cavity of the lower cylinder 45. A metal rod 49, which is longer than the total length or height of the passage 42, is inserted into the passage 42 so as to project upwardly and downwardly from the upper cylinder 47. The metal rod 49 is screwed or adhesively bonded into the passage 42.

At its upper free end 59.a projecting outside the second cylinder, the metal rod 49 has a slot forming a split head 55 which is capable of cooperating with a screwdriver.

The free end of the second cylinder is able to cooperate with the connector of the electric ignition harness (not shown) for the purpose of electrically connecting said harness and the metal rod 49.

The lower cylinder 45 has a port 51 to enable the operator to see the spark being created between the metal rod 49 and the central electrode of the spark plug 23. This port 51 extends from the radial outer face 55 of the lower cylinder 45 and opens into the cavity 53 of the first cylinder close to the lower end 59.b of the metal rod 59. To improve the visibility of the sparks, an optical fiber or a transparent bar can be inserted into the viewing port 51.

In order to test a spark plug, the electric ignition harness connecting the plug 23 to the rest of the ignition circuit is disconnected. The device 41 according to the invention is then positioned on the shell 37 of the spark plug 21. The cavity 53 of the first cylinder has a larger diameter than that part of the plug 23 which extends out of the cylinder head 21 of the engine and which is surrounded by the device 41, but has a smaller diameter than the shell 37 of the plug 23. This allows the external part of the spark plug 23 to be inserted into the cavity 53 of the insulating element 41. While it is being mounted, the device 41 butts against the upper face 37.a of the shell 37 of the spark plug 23. The device 41 is dimensioned such that the metal rod 49 is coaxial with the spark plug 23, and such that there is a non-zero distance “d” between the mutually facing ends of the conducting free end 33 of the spark plug 23 and said metal rod 49.

In the case of a metal rod screwed into the passage running through the upper cylinder 47, the distance “d” can also be adjusted, thanks to the slot 55, by an operator using a screwdriver. Adjusting this distance makes it possible to adjust the value of the additional voltage necessary for establishing an electric arc between the metal rod 49 and the central electrode of the spark plug 23.

The engine is then put into operation. If the ignition coil is deficient, the voltage that it provides will be insufficient for the formation of a spark, on the one hand between the metal rod 49 of the central electrode of the spark plug, and, on the other hand, between the electrodes of the spark plug 23. Misfires will then occur. These measured or perceived misfires, or an increase in the rate of misfires, will indicate that the coil is presumed to be faulty. Furthermore, by virtue of the port 51, the operator will be able to see if the test sparks appear and visually check that the test is proceeding correctly.

According to the invention, the insulating tube 27 or 41 can be made of a transparent material.

The invention makes it possible to control the voltage that the spark plug will have to supply during test phases.

1-11. (canceled)

12. A diagnostic method for diagnosing operation of an ignition coil of an internal combustion engine, further including at least one electric cable connecting the ignition coil to at least one spark plug installed in a cylinder head of the engine, the method comprising:
temporarily introducing a voltage-controlled switch into the ignition circuit;
making the coil provide a diagnostic voltage, which is above a threshold value necessary for the plug to form a spark, so as to cause formation of a spark between the central electrode of the spark plug and a conducting element of the switch; and
checking actual formation of a spark in response to providing the diagnostic voltage.

13. The diagnostic method as claimed in claim 12, wherein the checking measures engine misfires.

14. The diagnostic method as claimed in claim 13, wherein the checking views an image of current flowing through the switch.

15. The diagnostic method as claimed in claim 14, wherein the checking views a spark produced within the switch.

16. A diagnostic device for diagnosing operation of an ignition coil of an internal combustion engine, further including at least one electric cable connecting the coil to at least one spark plug, and at least one spark plug installed in a cylinder head of the engine, the device comprising:
a conducting element configured to be electrically and temporarily connected to the ignition coil to be tested, and configured to be arranged, during a diagnostic test, at an adjustable non-zero distance from the part, outside the cylinder head, of a central electrode of the spark plug so as to allow formation of a spark, between the central electrode of the spark plug and the conducting element during operation of the engine.

17. The diagnostic device as claimed in claim 16, wherein the conducting element is fixedly attached to an insulating element in which it is partially inserted, and the length of the element is a function of the adjustable non-zero distance.

18. The device as claimed in claim 17, wherein the conducting element includes a metal rod arranged in a passage formed in the insulating element, the rod projecting inside and outside the insulating element.

19. The device as claimed in claim 18, wherein the insulating element includes a tube and the passage is substantially coaxial with the axis of the insulating tube, the rod being adhesively bonded or screwed to the tube over a portion of its length.

20. The device as claimed in claim 18, wherein the conducting element includes a central electrode of a spark plug not provided with its ground electrode, the test plug being partially inserted into the insulating tube at its end opposed to the spark plug.

21. The device as claimed in claim 19, further comprising an inspection port for inspecting the spark being created in the insulating tube during the diagnostic test.

22. The device as claimed in claim 21, further comprising an element facilitating view of the test spark inserted into the inspection port.
